(19) United States
(12) Patent Application Publication
(10) Pub. No.: US 2018/0066336 A1
(43) Pub. Date: Mar. 8, 2018

(54) LASER PROCESSING DEVICE

(71) Applicant: Kabushiki Kaisha Toshiba, Minato-ku (JP)

(72) Inventors: Tetsuo Sakai, Taito (JP); Hiroshi Ohno, Yokohama (JP); Itaru Chida, Kawasaki (JP); Kota Nomura, Yokohama (JP)

(73) Assignee: Kabushiki Kaisha Toshiba, Minato-ku (JP)

(21) Appl. No.: 15/695,655

(22) Filed: Sep. 5, 2017

(30) Foreign Application Priority Data
Sep. 5, 2016 (JP) 2016-172422

(51) Int. Cl. C21D 10/00; B23K 26/00; B23K 26/064; B23K 26/146

(52) U.S. Cl. CPC C21D 10/005; B23K 26/146; B23K 26/064; B23K 26/0069

(57) ABSTRACT

According to one embodiment, a laser processing device includes a light irradiation section, and a mirror. The light irradiation section is adapted to emit a laser beam from a light source from a tip. The mirror is opposed to the tip of the light irradiation section. The mirror is adapted to reflect the laser beam emitted from the light irradiation section with an aspherical reflecting surface. An angle formed between the laser beam transmitted from the light irradiation section to the mirror and the laser beam reflected by the mirror is equal to or larger than 90 degrees.

### CROSS-REFERENCE TO RELATED APPLICATIONS

This application is based upon and claims the benefit of priority from Japanese Patent Application No. 2016-172422, filed on Sep. 5, 2016; the entire contents of which are incorporated herein by reference.

### FIELD

Embodiments of the invention generally relate to a laser processing device.

### BACKGROUND

It is possible for a laser beam to concentrate high density light energy on a narrow area. Therefore, processing with a laser beam is used in a wide variety of fields such as the nuclear field. As the processing technology with the laser beam, there can be cited laser peening for irradiating a metal surface in water with the laser beam to change the composition of the metal surface using a shock wave of the plasma generated by the irradiation with the laser beam. The laser peening is applied to a structure in a nuclear reactor, and reduces the stress in the structure to prevent corrosion fractures.

In the laser peening, the laser beam is reflected by an optical element such as a mirror to converge the laser beam on the metal surface. Depending on the position with respect to the metal surface on which the laser beam is converged, the optical element is apt to be affected by the shock wave of the plasma. Thus, there is a problem that the optical element is damaged.

### BRIEF DESCRIPTION OF THE DRAWINGS

FIG. 1 is a schematic diagram showing a laser processing device according to a first embodiment;

FIG. 2 is a partial enlarged view of FIG. 1;

FIG. 3 is a diagram showing a laser processing device according to a comparative example; and

FIG. 4 is a schematic diagram showing a laser processing device according to a second embodiment.

### DETAILED DESCRIPTION

According to one embodiment, a laser processing device includes a light irradiation section, and a mirror. The light irradiation section is adapted to emit a laser beam from a light source from a tip. The mirror is opposed to the tip of the light irradiation section. The mirror is adapted to reflect the laser beam emitted from the light irradiation section with an aspherical reflecting surface. An angle formed between the laser beam transmitted from the light irradiation section to the mirror and the laser beam reflected by the mirror is equal to or larger than 90 degrees.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described thereinabove are marked with like reference numerals, and a detailed description is omitted as appropriate.

### First Embodiment

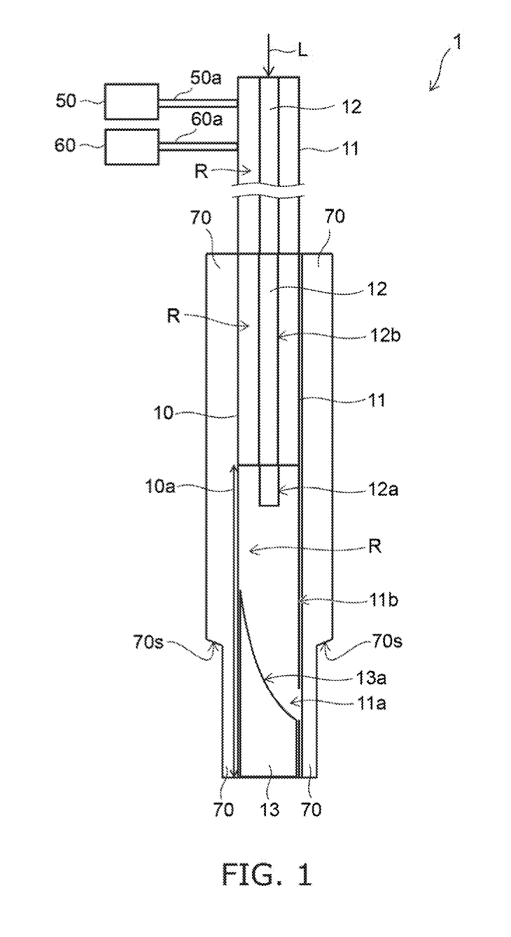

FIG. 1 is a schematic diagram showing a laser processing device according to a first embodiment.

As shown in FIG. 1, the laser processing device 1 is provided with a main body part 10, a drive section 50, and a liquid feeding section 60. The laser processing device 1 is a device for performing the laser peening on, for example, a pipe 70 as a processing object.

The laser peening denotes a processing technology using a laser such as a YAG laser. The laser beam is converged using an optical element such as a lens or a mirror, and a metal surface is irradiated with the laser beam thus converged to thereby generate plasma, and thus, compressive stress is provided inside the metal due to a shock wave of the plasma. By removing tensile stress remaining inside the metal to reduce the stress using the laser peening, corrosion fractures of the metal are prevented. Such laser peening is applied to, for example, a structure in a nuclear reactor.

The main body part 10 is provided with a housing 11, an optical fiber 12 (the light irradiation section), and a reflecting mirror 13.

The housing 11 has a hollow cylindrical shape, and houses the optical fiber 12 and the reflecting mirror 13 inside. The housing 11 is provided with an opening 11a.

The optical fiber 12 has a tip part 12a and a connecting part 12b. The laser beam L from a laser source (not shown) passes through the connecting part 12b, and is then emitted from the tip part 12a. For example, the laser beam L is a short-pulse laser beam with the pulse width equal to or shorter than 100 (ns).

The reflecting mirror 13 includes metal such as copper. The reflecting mirror 13 has a reflecting surface 13a opposed to the tip part 12a of the optical fiber 12. The reflecting surface 13a is provided with a film formed of a dielectric material. In other words, the reflecting mirror 13 is configured with a dielectric film disposed on an electrically conductive material including metal. Thus, the reflecting mirror 13 is prevented from being damaged by the laser beam L. It should be noted that the dielectric film can be a single layer film, or can be a multilayer film.

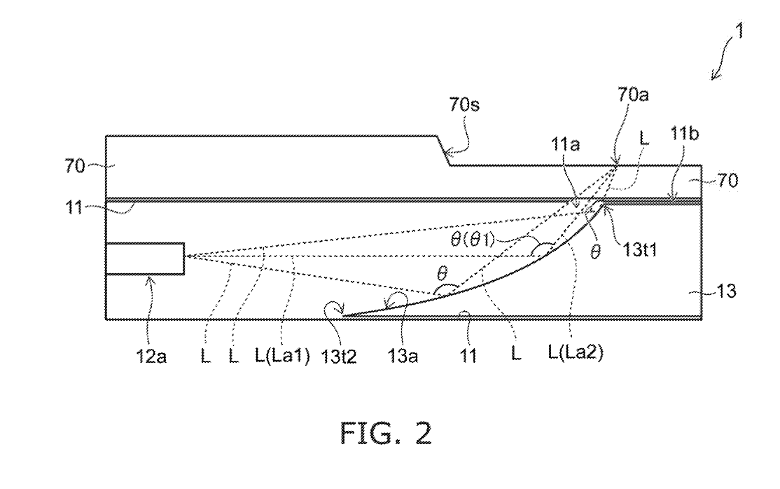

The reflecting mirror 13 reflects the laser beam L emitted from the tip part 12a of the optical fiber 12. The reflecting mirror 13 bends the incident laser beam from the tip part 12a to transmit the laser beam to the opening 11a, and converges the laser beam on a processing part (a processing part 70a shown in FIG. 2) of the pipe 70.

The drive section 50 is a drive device for moving the main body part 10 in up and down directions, and rotating the main body part 10. The drive section 50 is connected to the main body part 10 via a connection part 50a.

For example, the drive section 50 moves the housing 11 housing the optical fiber 12 and the reflecting mirror 13 in the up and down directions to thereby move the main body part 10 in the up and down directions.

For example, by providing the housing 11 with a rotating part having a hollow cylindrical shape and a support part disposed in the periphery of the rotating part and rotatably supporting the rotating part, the drive section 50 rotates the housing 11 to thereby rotate the main body part 10.

It should be noted that in the specification, the “up direction” denotes a direction from the reflecting mirror 13 toward the optical fiber 12, and the “down direction” denotes a direction from the optical fiber 12 toward the reflecting mirror 13.

In the case of performing the laser peening, by the drive section 50 driving the main body part 10, the position of the irradiation part 10a of the main body part 10 relative to the pipe 70 is adjusted. For example, in the case in which the main body part 10 is embedded in the pipe 70, by moving the main body part 10 in the up direction and rotating the main body part 10 in the vertical direction (e.g., a vertical direction with respect to the drawing), the position of the irradiation part 10a relative to the pipe 70 is adjusted. Thus, the positions of the tip part 12a of the optical fiber 12 and the reflecting surface 13a of the reflecting mirror 13 are adjusted, and it is possible to perform the laser peening on the processing part of the pipe 70.

The liquid feeding section 60 has a function of supplying the liquid such as water into the housing 11 of the main body part 10. The liquid feeding section 60 is connected to the housing 11 via a supply pipe 60a. In the housing 11, there is formed a flow channel R for flowing the liquid supplied from the liquid feeding section 60. The flow channel R is formed so that the liquid flows in the housing 11 and is supplied to the processing part of the pipe 70. It should be noted that the flow channel R is formed downward, and the liquid supplied from the liquid feeding section 60 flows downward in the housing 11 via the flow channel R.

For example, by forming a gap, through which the liquid flows, between an outer wall surface 11b of the housing 11 and the pipe 70, the liquid in the flow channel R flows through the opening 11a of the housing 11, and is then supplied to the processing part of the pipe 70 through the gap. Subsequently, the liquid flows in the opposite direction (the up direction) to the forming direction of the flow channel R via the gap disposed between the housing 11 and the pipe 70. Then, the liquid is discharged from the upper end side of the pipe 70.

The pipe 70 has a hollow cylindrical shape. The main body part 10 of the laser processing device 1 is inserted in the pipe 70. Therefore, the pipe 70 is located on the outer wall surface 11b of the housing 11 so as to surround the periphery of the housing 11 of the main body part 10.

For example, the pipe 70 is provided with a part (a step 70s) tapered downward. In this case, the step 70s is a part inversely tapered in the direction (the up direction) in which the main body part 10 embedded in the pipe 70 is moved.

FIG. 2 is a partial enlarged view of FIG. 1.

In FIG. 2, there is shown a configuration of converging the laser beam L on the processing part 70a of the pipe 70 using the laser processing device 1.

The reflecting surface 13a of the reflecting mirror 13 is an aspherical surface. For example, as shown in FIG. 2, the shape of the reflecting surface 13a is a paraboloid. The shape of the reflecting surface 13a can also be a hyperboloid or an ellipsoid. In the case in which the shape of the reflecting surface 13a is a paraboloid or a hyperboloid, it becomes easy to converge the laser beam L reflected by the reflecting surface 13a on the processing part 70a of the pipe 70 compared to the case in which the shape of the reflecting surface 13a is an ellipsoid.

In the case in which the shape of the reflecting surface 13a is aspherical, the shape of the reflecting surface 13a depends on, for example, the conic constant k. For example, in the case in which the shape of the reflecting surface 13a is expressed by a predetermined formula (an amount of sag) including the conic constant k, if the conic constant k is −1, the shape of the reflecting surface 13a becomes a paraboloid. Further, if the conic constant k is smaller than −1, the shape of the reflecting surface 13a is a hyperboloid, and if the conic constant k is greater than −1 and smaller than 0, the shape of the reflecting surface 13a becomes an ellipsoid.

As represented by the dotted lines in FIG. 2, the laser beam L is emitted from the tip part 12a of the optical fiber 12. The laser beam L is reflected by the reflecting surface 13a of the reflecting mirror 13 to converge on the processing part 70a of the pipe 70.

It should be noted that in the example shown in FIG. 2, the part on which the laser beam L converges in the pipe 70 coincides with the processing part 70a. In other words, the point on which the laser beam L converges coincides with the processing point. The part on which the laser beam L converges is not required to coincide with the processing part 70a, and can also be the vicinity of the processing part 70a.

The angle θ formed between the laser beam L transmitted from the tip part 12a to the reflecting surface 13a and the laser beam L reflected by the reflecting surface 13a and then transmitted to the processing part 70a is equal to or larger than 90 degrees. For example, the angle θ is larger than 90 degrees and smaller than 180 degrees.

Here, in the case in which an optical axis La1 corresponds to the optical axis of the laser beam L transmitted from the tip part 12a to the reflecting surface 13a, and an optical axis La2 corresponds to the optical axis of the laser beam L transmitted from the reflecting surface 13a to the processing part 70a, the angle θ1 formed between the optical axis La1 and the optical axis La2 is equal to or larger than 90 degrees.

Here, the position of the reflecting mirror 13 with respect to the tip part 12a is determined in the main body part 10 so that the angle θ becomes equal to or larger than 90 degrees. For example, by adjusting the tilt of the reflecting surface 13a with respect to the tip part 12a, the angle θ becomes equal to or larger than 90 degrees. Specifically, since the shape of the reflecting surface 13a is aspherical, by adjusting the positions of the ends 13t1, 13t2 of the reflecting surface 13a with respect to the housing 11, the angle θ becomes equal to or larger than 90 degrees. Here, the ends 13t1 corresponds to an end located below the end 13t2.

Since the angle θ is equal to or larger than 90 degrees, the processing part 70a is not located above the reflecting surface 13a. For example, in the down direction, the end 13t1 of the reflecting surface 13a is located between the end 13t2 of the reflecting surface 13a and the processing part 70a.

Further, since the angle θ is equal to or larger than 90 degrees, even in the case in which the processing part 70a is located in the step 70s, the laser beam L transmitted from the reflecting surface 13a enters the tapered step 70s at a predetermined angle. Thus, the step 70s is apt to be irradiated with the laser beam L.

In the case of performing the laser peening using the laser processing device 1 according to the embodiment, by the drive section 50 firstly moving the main body part 10 in the up and down directions and then rotating the main body part 10, the position of the irradiation part 10a of the main body part 10 relative to the pipe 70 is adjusted. Then, the laser beam L is emitted from the tip part 12a. Subsequently, the laser beam L is reflected by the reflecting surface 13a, and the processing part 70a of the pipe 70 is irradiated with the laser beam L.

Advantages of the embodiment will hereinafter be described.

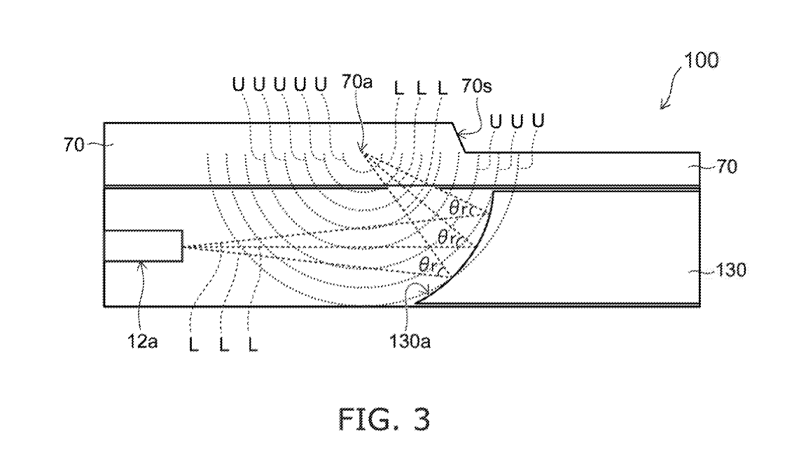

FIG. 3 is a diagram showing a laser processing device according to a comparative example.

In FIG. 3, there is shown a configuration of converging the laser beam L on the processing part 70a of the pipe 70 using the laser processing device 100.

In the embodiment, in the laser processing device 1 provided with the reflecting mirror 13 having the aspherical reflecting surface 13a, the angle θ formed between the laser beam L transmitted from the tip part 12a of the optical fiber 12 to the reflecting surface 13a and the laser beam L reflected by the reflecting surface 13a and transmitted to the processing object (the pipe 70) is equal to or larger than 90 degrees. Further, if the processing object is irradiated with the laser beam L using such a laser processing device 1, the processing point (the processing part 70a) is not located above the reflecting surface 13a.

In contrast, as represented by the dotted lines in FIG. 3, in the laser processing device 100, the angle θr formed between the laser beam L transmitted from the tip part 12a of the optical fiber 12 to the reflecting surface 130a of the reflecting mirror 130 and the laser beam L reflected by the reflecting surface 130a and transmitted to the processing part 70a is smaller than 90 degrees. In this case, it results that the processing part 70a is located above the reflecting surface 130a.

If the angle θr is smaller than 90 degrees, in the case in which the processing part 70a is located in the step 70s tapered downward, it is difficult to irradiate the step 70s with the laser beam L from the reflecting surface 130a. Thus, depending on the shape of the pipe 70, it is difficult to perform the laser peening using the laser processing device 100 in some cases.

Further, if the processing part 70a is located above the reflecting surface 130a, it results that the processing part 70a is located close to the tip part 12a of the optical fiber 12 and the reflecting surface 130a of the reflecting mirror 130. Thus, the optical fiber 12 and the reflecting mirror 130 are apt to be affected by the shock wave of the plasma generated in the processing part 70a. Further, due to the plasma, there is induced generation of an ultrasonic wave U originated from the processing part 70a as a sound source. As represented by the dotted lines in FIG. 3, the ultrasonic wave U propagates through the pipe 70 and of the laser processing device 100, and the optical fiber 12 and the reflecting mirror 130 are apt to be affected by the ultrasonic wave U. Due to the shock wave of the plasma and the ultrasonic wave, the optical fiber 12 and the reflecting mirror 130 become apt to be damaged.

According to the embodiment, the angle θ formed between the laser beam L transmitted from the tip part 12a to the reflecting surface 13a and the laser beam L reflected by the reflecting surface 13a and then transmitted to the processing part 70a is equal to or larger than 90 degrees. Thus, even in the case in which the processing part 70a is located in the step 70s tapered downward, the laser beam L transmitted from the reflecting surface 13a enters the step 70s at a predetermined angle. Therefore, since the step 70s is apt to be irradiated with the laser beam L, it is possible to perform the laser peening using the laser processing device 1 independently of the shape of the pipe 70.

Further, in the embodiment, the processing part 70a is not located above the reflecting surface 13a. Therefore, compared to the configuration of converging the laser beam L shown in FIG. 3, the reflecting surface 13a becomes hard to be affected by the shock wave of the plasma. Further, since it is possible to elongate the distance between the processing part 70a and the tip part 12a, the optical fiber 12 becomes hard to be affected by the shock wave of the plasma generated in the processing part 70a and the ultrasonic wave generated by the plasma. Thus, the damage of the optical fiber 12 and the reflecting mirror 13 can be prevented.

According to the embodiment, there is provided the laser processing device with which the processing object is easily processed while preventing damages of the optical elements.

### Second Embodiment

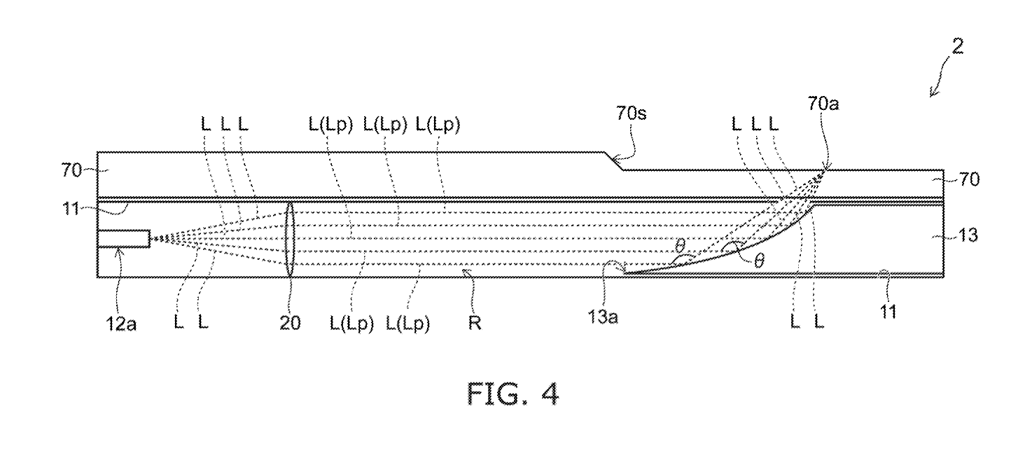

FIG. 4 is a schematic diagram showing a laser processing device according to a second embodiment.

It should be noted that the area shown in FIG. 4 corresponds to the area shown in FIG. 2.

The laser processing device 2 according to the embodiment is different from the laser processing device 1 according to the first embodiment in the point of providing a lens 20. The other constituents are the same as those of the first embodiment, and therefore, the detailed description will be omitted.

As shown in FIG. 4, the main body part 10 of the laser processing device 2 is provided with the housing 11, the optical fiber 12, the reflecting mirror 13, and the lens 20.

The lens 20 is disposed between the tip part 12a of the optical fiber 12 and the reflecting surface 13a of the reflecting mirror 13. The lens 20 is, for example, a collimating lens. By the lens 20, the laser beam L emitted from the tip part 12a of the optical fiber 12 is adjusted so as to become parallel light Lp.

In the laser processing device 2 according to the embodiment, the laser beam L is emitted from the tip part 12a of the optical fiber 12. Then, the laser beam L passes through the lens 20, and is then reflected by the reflecting mirror 13, and the processing part 70a of the pipe 70 is irradiated with the laser beam L.

The angle θ formed between the laser beam L transmitted from the lens 20 to the reflecting surface 13a and the laser beam L reflected by the reflecting surface 13a and then transmitted to the processing part 70a is equal to or larger than 90 degrees. For example, the angle θ is larger than 90 degrees and smaller than 180 degrees.

Advantages of the embodiment will hereinafter be described.

In the embodiment, the lens 20 is disposed between the optical fiber 12 and the reflecting mirror 13, and the lens 20 adjusts the laser beam L from the optical fiber 12 to be the parallel light Lp. By adjusting the laser beam L to be the parallel light Lp with the lens 20, it is possible to increase the distance between the lens 20 and the reflecting mirror 13 (the reflecting surface 13a) as shown in FIG. 4. Thus, the length of the flow channel R formed between the tip part 12a and the reflecting surface 13a in the housing 11 can sufficiently be ensured, and therefore, it becomes easy for the liquid in the flow channel R to flow in the state of a laminar flow.

Since the liquid in the flow channel R flows in the state of a laminar flow, bubbles are hard to occur in the flow channel R. In the case in which the laser beam L is transmitted between the tip part 12a and the reflecting surface 13a, scattering of the light due to the laser beam L generated by the bubbles can be prevented.

The other advantages are the same as the advantages of the first embodiment.

According to the embodiment, there is provided the laser processing device with which the processing object is easily processed while preventing damages of the optical elements.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A laser processing device comprising:
a light irradiation section adapted to emit a laser beam from a light source from a tip; and
a mirror opposed to the tip of the light irradiation section, and adapted to reflect the laser beam emitted from the light irradiation section with an aspherical reflecting surface,
an angle formed between the laser beam transmitted from the light irradiation section to the mirror and the laser beam reflected by the mirror being equal to or larger than 90 degrees.

2. The device according to claim 1, wherein
an angle formed between an optical axis of the laser beam transmitted from the light irradiation section to the mirror and an optical axis of the laser beam reflected by the mirror is equal to or larger than 90 degrees.

3. The device according to claim 1, wherein
the angle is larger than 90 degrees and smaller than 180 degrees.

4. The device according to claim 1, wherein
a shape of the reflecting surface is one of a paraboloid, a hyperboloid, and an ellipsoid.

5. The device according to claim 1, wherein
the reflecting surface has one end and the other end, a distance between the other end and the light irradiation section in a first direction from the light irradiation section toward the mirror being shorter than a distance between the one end and the light irradiation section in the first direction,
in the first direction, the one end of the reflecting surface is located between the other end of the reflecting surface and a point on which the laser beam reflected by the mirror converges.

6. The device according to claim 1, further comprising:
a lens provided between the tip of the light irradiation section and the reflecting surface of the mirror, and adapted to adjust a spread angle of the laser beam transmitted from the light irradiation section.

7. The device according to claim 6, further comprising:
a housing adapted to house the light irradiation section and the mirror inside; and
a liquid feeding section connected to the housing, and adapted to flow a liquid inside the housing,
wherein a flow channel through which the liquid flows is formed between the tip of the light irradiation section and the reflecting surface of the mirror in the housing, and
a flow of the liquid in the flow channel is in a state of a laminar flow.

8. The device according to claim 7, wherein
the housing is provided with an opening, and
the laser beam reflected by the mirror is transmitted to a processing object via the opening.

9. The device according to claim 7, further comprising:
a drive section adapted to move the housing in a first direction from the light irradiation section toward the mirror and a second direction opposite to the first direction, and rotate the housing.

10. The device according to claim 1, wherein
the light irradiation section includes a tip part adapted to emit the laser beam, and a connecting part provided between the light source and the tip part.

11. The device according to claim 1, wherein
the mirror includes a metal material.

12. A laser processing device comprising:
a light irradiation section adapted to emit a laser beam from a light source from a tip;
a lens opposed to the tip of the light irradiation section, and adapted to adjust a spread angle of the laser beam transmitted from the light irradiation section; and
a mirror provided so that the lens is located between the light irradiation section and the mirror, and adapted to reflect the laser beam transmitted from the lens with an aspherical reflecting surface,
an angle formed between the laser beam transmitted from the lens to the mirror and the laser beam reflected by the mirror being equal to or larger than 90 degrees.

13. The device according to claim 12, wherein
an angle formed between an optical axis of the laser beam transmitted from the lens to the mirror and an optical axis of the laser beam reflected by the mirror is equal to or larger than 90 degrees.

14. The device according to claim 12, wherein
the angle is larger than 90 degrees and smaller than 180 degrees.

15. The device according to claim 12, wherein
a shape of the reflecting surface is one of a paraboloid, a hyperboloid, and an ellipsoid.

16. The device according to claim 12, wherein
the reflecting surface has one end and the other end, a distance between the other end and the light irradiation section in a first direction from the light irradiation section toward the mirror being shorter than a distance between the one end and the light irradiation section in the first direction, and
in the first direction, the one end of the reflecting surface is located between the other end of the reflecting surface and a point on which the laser beam reflected by the mirror converges.

17. The device according to claim 12, further comprising:
a housing adapted to house the light irradiation section, the lens, and the mirror inside; and
a liquid feeding section connected to the housing and adapted to flow a liquid inside the housing,
wherein a flow channel through which the liquid flows is formed between the tip of the light irradiation section and the reflecting surface of the mirror in the housing, and
a flow of the liquid in the flow channel is in a state of a laminar flow.

18. The device according to claim 17, further comprising:
the housing is provided with an opening, and
the laser beam reflected by the mirror is transmitted to a processing object via the opening.

19. The device according to claim 17, further comprising:
a drive section adapted to move the housing in a first direction from the light irradiation section toward the mirror and a second direction opposite to the first direction, and rotate the housing.

20. The device according to claim 12, further comprising:
the light irradiation section includes a tip part adapted to emit the laser beam, and a connecting part disposed between the light source and the tip part.
